(19) United States
(12) Patent Application Publication
(10) Pub. No.: US 2005/0221758 A1
(43) Pub. Date: Oct. 6, 2005

(54) Touch-entry user input device

(76) Inventor: Thomas Busse, Erkrath (DE)

Correspondence Address: HARRINGTON & SMITH, LLP, 4 RESEARCH DRIVE, SHELTON, CT, 06484-6212, US

(21) Appl. No.: 10/518,735

(22) PCT Filed: Jul. 23, 2002
(86) PCT No.: PCT/IB02/02985

§ 371 Date: Dec. 16, 2004

(30) Foreign Application Priority Data
Jun. 18, 2002 (GB) 0213973.1

(51) Int. Cl. H04B 7/00

(52) U.S. Cl. 455/41.2; 455/550.1

(57) ABSTRACT

A touch-entry user input device having a first mode in which the device does not perform a first function and a second mode in which the device does perform the first function wherein the device has means for user input and is arranged, when in the first mode, to initiate exit from the first mode and entry into the second mode at the initiation of a user input.

The present invention relates to a touch entry user input device. It particularly relates to a touch entry user input device located remotely from the device to which input is supplied.

Currently mobile phones have an integrated touch-entry user input, such as a keypad. A key of the keypad may have a different function depending upon the manner in which it is actuated. For example, when the phone is being used for text entry a single actuation of a key can produce a particular character and the repeated actuation of the key in rapid succession can produce different characters. Also, when the phone is in idle mode, the actuation of a key by depressing and releasing the key produces a numeric character as part of a telephone number to be dialed and the actuation of the same key by depressing the key for a duration exceeding about 1 second and then releasing it instructs the phone to dial a stored number. This is called “one-touch” dialing.

The Bluetooth (Trademark) standard describes how low power radio transceivers can be used to remotely communicate over a range of tens of metres. These low power transceiver devices are already present in some mobile phones and can be used to allow a user input (e.g. a cordless headset) to be used remotely from the mobile phone. Communication between the headset and the phone occurs between a low power radio transceiver in the headset and the low power radio transceiver in the phone. A particular advantage of Bluetooth transceivers in mobile applications is that they have energy conservation modes which prolong battery life.

It would be desirable to improve existing user input devices, in particular, touch-entry input devices comprising Bluetooth transceivers.

According to one aspect of the present invention there is provided a touch-entry user input device having a first mode in which the device does not perform a first function and a second mode in which the device does perform the first function wherein the device has means for user input and is arranged, when in the first mode, to initiate exit from the first mode and entry into the second mode at the initiation of a user input.

According to another aspect of the present invention there is provided a method of transferring a user input device in response to user input from a first mode in which the device is not capable of performing a first function to a second mode in which the device is capable of performing a first function where there is an inherent delay in the transfer process, comprising the steps of: detecting the initiation of user input and then immediately initiating the transfer.

For a better understanding of the present invention reference will now be made by way of example only to the drawings in which:

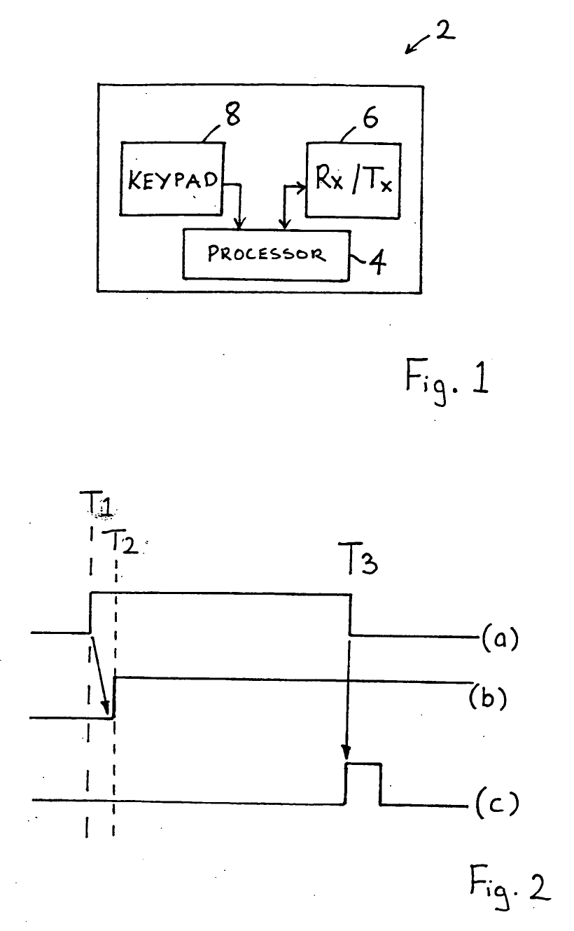

FIG. 1 illustrates a touch-entry user input device 2 according to one embodiment of the present invention and

FIG. 2 illustrates timing.

According to the Bluetooth Standard, transceiver devices communicate by forming a piconet. A transceiver device can operate as either a Master or a Slave. When operating as a Master, the transceiver controls the piconet and the timing of the piconet is synchronised to the timing of the Master. Communication in the piconet occurs using packets in a time divided manner with only one device transmitting in any one time slot. The time slot is 625 microseconds duration. The Master assigns an Active Member Address AM_ADDR to each Slave participating in the piconet and transmits to and receives from any one of the participating Slave devices using the appropriate AM_ADDR. It can transmit in the even time slots and can receive in the odd time slots. When operating as a Slave, the transceiver can communicate with only the Master of the piconet. It receives in one slot and transmits in the next slot.

When a Slave is in the Active Mode, it is participating in the piconet. It has an AM_ADDR and keeps synchronised to the Master. It continually listens to receive packets addressed to it. It can transmit packets to the Master.

When a Slave is in the Sniff Mode, it has an AM_ADDR and keeps synchronised to the Master. The Master sends a ‘sniff’ packet to the Slave once every ‘sniff interval’ Tsniff. The inventor has realised that there is a variable delay D between when a Bluetooth transceiver decides to exit the Sniff Mode and when it enters the Active Mode. The inherent variable delay D includes the variable period before the device is able to receive a ‘sniff’ packet (and is therefore able to transmit a message to initiate exit from the Sniff Mode) and the time taken to exit the Sniff Mode. The variable period may be as long as Tsniff. The time taken to exit the Sniff Mode is the time required to transmit the message to the Master and to receive a message in reply.

When a Slave is in the Park Mode, it gives up its AM_ADDR It is not able to transmit data to the Master. The Master controls the Slave to move from a Park Mode to an Active Mode by transmitting an ‘unpark’ packet to the Slave once every ‘park interval’. The Slave, while parked, regularly listens for an ‘unpark’ packet addressed to it and sent by the Master and in the regular ‘park intervals’ between these attempts is switched off. The inventor has realised that there is a variable delay D between when a Bluetooth transceiver decides to exit the Park Mode and when it enters the Active Mode. The inherent variable delay D includes the variable period before the device receives an ‘unpark’ packet (and is able transmit a message to initiate exit from the Park Mode) and the time taken to exit the Park Mode. The variable period may be as long as the ‘park interval’. The time taken to exit the Park Mode is the time required to transmit a reply message to the Master.

The inventor has realised that when the touch entry device is capable of discriminating between an instantaneous depression of a key and a continuous depression of a key lasting more than a threshold T, it may take the device at least the threshold T to discriminate a user input. Therefore there will be a delay between the user first making an input keystroke, when the input device is in the Sniff or Park Modes, and the response from the device to which the entry is transmitted of the threshold T (for discrimination) plus the variable delay D (for entering the Active Mode).

The inventor has developed an effective yet simple solution to the problem of a long variable delay. The delay D is made less than the threshold and a decision to exit the Sniff/Park Mode and enter the Active Mode is made before the keystroke input has been discriminated. The threshold is typically 0.8 seconds and the delay D is made less than this, for example, by setting Tsniff and the ‘park interval’ to less than 0.8 seconds and preferably 0.5 seconds. Preferably, the decision to exit the Sniff/Park Mode and enter the Active Mode is made at the beginniug of the keystroke and the Active Mode is entered before the user input has been discriminated.

FIG. 1 illustrates a touch-entry user input device 2 according to one embodiment of the present invention. The touch-entry user input device 2 comprises a processor 4 connected to a low power radio transceiver 6 which communicates in accordance with the Bluetooth Standard, and to a keypad 8 of user depressible keys. The touch-entry user input device 2 operates as a Slave or a Master in a Bluetooth piconet. The user can input data or commands using keystrokes on the keypad 8. The processor 4 detects and identifies each keystroke and controls the low power radio transceiver to send a radio packet comprising data identifying a keystroke to a remote device (not shown).

The touch-entry user input device 2 has a first operational mode (an energy conservation mode) in which the low power radio transceiver 6 is in the Sniff Mode or the Park Mode and is not readily capable of transmitting keystroke data. The touch-entry user input device 2 has a second operational mode (a radio communication mode) in which the low power radio transceiver is in the Active Mode and is readily capable of transmitting keystroke data.

The interval in the Park Mode is 0.5 seconds and Tsniff is 0.5 seconds.

The processor 4 is programmed to detect, when the device is in the first mode, the initiation (as opposed to completion) of a user input keystroke. The detection of the keystroke occurs at the same time irrespective of whether the keystroke is an instantaneous depression of a key, a continuous depression of a key or a repetitive depression of a key. When the processor 4 detects the initiation of a keystroke it automatically and immediately initiates the exit from the first mode and entry into the second mode. The processor 4 initiates the exit by instructing low power radio transceiver 6 to exit the Sniff Mode or Park Mode. The low power transceiver 6 exits the Sniff Mode by transmitting a LMP_unsniff_req message and receiving a LMP_unsniff_accepted message from the Master in reply and data can be transmitted immediately. The low power transceiver 6 exits the Park Mode by receiving a LMP_unpark_BD_ADDR_req or LMP_unpark_PM_ADDR_req message from the Master. This provides an AM_ADDR to the slave. The slave replies by transmitting a LMP_accepted message to the Master and the Park Mode is exited.

The processor 4 is also programmed to discriminate between an instantaneous depression of a key, a continuous depression of a key and a repetitive depression of a key. A continuous depression is one lasting more than a threshold, for example 0.8 seconds. Once the keystroke has been discriminated, the processor instructs the low power radio transceiver to send a message identifying the keystroke. If the device is in the first mode when a keystroke is made, the initiation of the exit from the first mode is completed before discrimination of the user input. Preferably, the entrance into the second mode has been completed before the discrimination of the user input. Thus once the keystroke has been discriminated the message identifying it may be sent immediately.

FIG. 2 illustrates the timing. The trace (a) illustrates the timing of the depression of a key. The key is depressed for time t (t=T3−T1). The trace (b) illustrates the timing of the Active Mode. The trace (c) illustrates the timing of keystroke message transmissions. At time T1, the user starts to press the key. At time T2, the touch-entry user input device 2 enters the Active Mode. At time T3 the user input keystroke ends and is discriminated and a message identifying the keystroke is sent. Therefore the reaction times when using a remote touch-entry user input device are reduced. Furthermore, the time at which the message containing the keystroke is sent does not vary.

Although the invention has been described in the preceding paragraphs with reference to various examples, it should be appreciated that modifications and variations to the examples given can be made without departing from the scope of the invention as claimed.

Whilst endeavouring in the foregoing specification to draw attention to those features of the invention believed to be of particular importance it should be understood that the Applicant claims protection in respect of any patentable feature or combination of features hereinbefore referred to and/or shown in the drawings whether or not particular emphasis has been placed thereon.

1. A touch-entry user input device having a first mode in which the device does not perform a first function and a second mode in which the device does perform the first function wherein the device has means for user input and is arranged, when in the first mode, to initiate exit from the first mode and entry into the second mode at the initiation of a user input.

2. A touch-entry user input device as claimed in claim 1 comprising detection means for detecting the initiation of a user input and control means for initiating the exit from the first mode.

3. A touch-entry user input device as claimed in claim 1 wherein the first mode is an energy conservation mode.

4. A touch-entry user input device as claimed in claim 1 wherein the second mode is a low power radio communication mode.

5. A touch-entry user input device as claimed in claim 1 wherein the means for user input comprises a user depressible key.

6. A touch-entry user input device as claimed in claim 5 comprising discrimination means for discriminating an instantaneous depression of the key from a continuous depression of the key.

7. A touch-entry user input device as claimed in claim 1 wherein the initiation of the exit from the first mode occurs before discrimination of the user input.

8. A touch-entry user input device as claimed in claim 1 wherein the entry into the second mode occurs before discrimination of the user input.

9. A touch-entry user input device as claimed in claim 1 further comprising low power radio transceiver means and wherein the exit from the first mode is initiated by sending a message using the low power radio transceiver means.

10. A touch-entry user input device as claimed in claim 1 further comprising low power radio transceiver means wherein the first function comprises transmitting data using the low power radio transceiver means.

11. A touch-entry user input device as claimed in claim 1 operating as a Slave in a Bluetooth piconet.

12. A touch-entry user input device as claimed in claim 1 operating in accordance with the Bluetooth Standard wherein the first mode is the Sniff Mode or Park Mode.

13. A touch-entry user input device as claimed in claim 12 wherein the exit from the Sniff Mode is initiated by transmitting a LMP_unsniff_req message.

14. A touch-entry user input device as claimed in claim 12 wherein the exit from the Park Mode is initiated by transmitting a LMP_accepted message.

15. A touch-entry user input device as claimed in claim 1 operating in accordance with the Bluetooth Standard wherein the second mode is the Active Mode.

16. A touch-entry user input device as claimed in claim 1 wherein the time taken to exit from the first mode and enter into the second mode is less than the time taken to discriminate a user input.

17. (canceled)

18. A method of transferring a user input device, in response to user input, from a first mode in which the device is not capable of performing a first function to a second mode in which the device is capable of performing a first function where there is an inherent delay in the transfer process, comprising the steps of:
detecting the initiation of user input and then immediately initiating the transfer.

19. A method as claimed in claim 18, wherein user input is performed by depressing a user depressible key.

20. A method as claimed in claim 19, further comprising the step of discriminating an instantaneous depression of the key from a continuous depression of the key.

21. (canceled)
